(19) United States
(12) Patent Application Publication
(10) Pub. No.: US 2025/0011944 A1
(43) Pub. Date: Jan. 9, 2025

(54) HYDROGEN PRODUCTION BY ELECTROCHEMICAL DECOMPOSITION OF SALINE WATER USING SULFUR DIOXIDE OR BISULFITE AS AN ANODE DEPOLARIZER

(71) Applicant: HYS ENERGY LTD, Bat-Yam (IL)

(72) Inventor: Gleb Nikolaevich TARABUKIN, Bat-Yam (IL)

(21) Appl. No.: 18/890,337

(22) Filed: Sep. 19, 2024

Related U.S. Application Data
(63) Continuation-in-part of application No. PCT/IL2023/050326, filed on Mar. 29, 2023.
(60) Provisional application No. 63/325,719, filed on Mar. 31, 2022.
(60) Provisional application No. 63/379,004, filed on Oct. 11, 2022.

(51) Int. Cl. C25B 1/04; C02F 1/44; C02F 3/34; C02F 103/08; C25B 9/23; C25B 11/077; C25B 15/08

(52) U.S. Cl. CPC C25B 1/04; C02F 1/442; C02F 3/345; C25B 9/23; C25B 11/077; C25B 15/083; C25B 15/087; C02F 2103/08

(57) ABSTRACT

A method and an electrochemical cell for hydrogen production by electrochemical decomposition of saline water in the presence of sulfur dioxide and/or bisulfite as an anode depolarizer and in the absence of alkanolamine-containing absorbent are disclosed.

### CROSS-REFERENCE TO RELATED PUBLICATIONS

This application is a Continuation-in-Part of International (PCT) Pat. Appl. No. PCT/IL2023/050326, filed 29 Mar. 2023, and claims priority from U.S. Provisional Pat. Appl. No. 63/325,719, filed 31 Mar. 2022, and from U.S. Provisional Pat. Appl. No. 63/379,004, filed 11 Oct. 2022. All of these documents are incorporated by reference in their entirety.

### FIELD OF THE INVENTION

This invention relates in general to means for, and methods of, electrolysis of water. It relates specifically to means and methods for production of hydrogen by electrochemical decomposition of saline water in which sulfur dioxide and/or bisulfite is used as an anode depolarizer.

### BACKGROUND OF THE INVENTION

Flue gas emitted by burning of sulfur-containing fossil fuels in power plants, incinerators, boilers, roasting of sulfide ore in metallurgy, and in production of sulfuric acid, and tail gases arising from incineration in sulfur recovery plants used in the oil and gas industry, are the major industrial sources of atmospheric sulfur dioxide (SO₂), which is a major atmospheric pollutant and source of acid rain. The adverse effects of SO₂ on human health and the environment make necessary its abatement in flue gases. This problem represents a significant industrial concern. To prevent this environmentally harmful gas from polluting the atmosphere, flue gas desulfurization (FGD) processes are required.

Many FGD processes have been developed, among them those using limestone, calcium hydroxide or magnesium hydroxide slurries, sodium hydroxide solutions, and some organic solvents as absorbents. The most well-known flue gas desulfurization processes are based mainly on scrubbing with limestone slurries of the flue gas. Typically, the byproduct is either discarded in a landfill or converted into gypsum for use in wallboard and cement manufacturing. Disposal in a landfill requires a large initial capital investment as well as significant resources to maintain the landfill throughout the life of the plant (“A Novel Selective Flue Gas SO₂ Removal with an Amine Absorbent”, H. Mehrara et al, Abadan Institute of Technology Petroleum University of Technology, 2013).

In response for the demand for lower cost flue-gas desulfurization technologies ABB Flakt and Norsk Hydro A. S. have jointly developed the Seawater FGD process known as the Flakt-Hydro process. The Flakt-Hydro process utilizes seawater's inherent capability for absorbing and neutralizing sulfur dioxide. Because seawater already contains 900 mg/l sulfur as a natural constituent, seawater can be used for the absorption of sulfur dioxide (SO₂) from flue gases and returned to the sea without detrimental effects on the environment. Seawater is used in large amounts at coastal power plants as the cooling medium in condensers. This seawater can be reused downstream of the condensers to control SO₂ emissions. The SO₂ is absorbed through close contact between the seawater and flue gas in a counter-current flow. Low-density packing is used to optimize the gas/liquid contact. No reagent is added or needed. The acidic effluent flows to the Sea Water Treatment Plant (SWTP), where the absorbed SO₂ is oxidized by aeration to form harmless SO₄²⁻, which is discharged into the sea. The sulfate is totally dissolved in the seawater. Since sulfate is a natural constituent of seawater, the seawater returned to the sea has only a slightly higher sulfate content. This increase lies well within variations occurring naturally in seawater, and even at a point located only a short distance from the point of discharge, the difference in SO₄²⁻ concentration from the background level can no longer be detected. The effluent discharge from the Flakt-Hydro seawater process has been extensively studied by independent environmental agencies (“Low-cost FGD systems for emerging markets”, Jonas S. Klingspor et al, ABB Environmental Systems, ABB Review #1/1988).

At the same time, it has long been realized that sulfur dioxide can serve as an anode depolarizer in water electrolysis process for hydrogen production. The hydrogen is a valuable energy source and is often used as an energy storage medium. As a product, hydrogen can be used as transport fuel in fuel cell electric vehicles or in its traditional markets, as an upgrader in refineries or as a commodity in many industrial processes.

Development of sulfur dioxide depolarized water electrolysis methods began about 50 years ago as part of an effort to find an economically efficient way to produce hydrogen. The Hybrid Sulfur Cycle (HyS) or Westinghouse process (also known as Ispra Mark 11) was patented in 1975 by Brecher and Wu (U.S. Pat. No. 3,888,750). It is a two-step process, comprising a low-temperature electrochemical step and a high temperature, thermochemical step. In the electrochemical step of the HyS cycle, sulfuric acid and hydrogen are produced by sulfur dioxide depolarized electrolysis (SDE). In the thermochemical part, the sulfuric acid formed in electrolysis is concentrated and decomposed thermally to SO₂ and O₂. The SO₂ is recirculated back to the electrolysis step for hydrogen generation.

In the Westinghouse process, separate liquid streams feed the electrolyzer and are referred to as the catholyte and the anolyte. The catholyte is an aqueous solution of sulfuric acid and the anolyte is an aqueous solution of sulfuric acid and dissolved SO₂. Sulfur dioxide is oxidized at the anode to produce sulfuric acid and protons. Thus, the outlet anolyte stream has a higher concentration of sulfuric acid than the inlet anolyte stream. The protons produced at the anode are transported as hydronium ions across the cation-exchange membrane of the electrolyzer into the catholyte and are reduced at the cathode to produce hydrogen gas.

In conventional water electrolysis, water is dissociated yielding hydrogen gas at the cathode and oxygen gas at the anode. The electrochemical decomposition energy of water is relatively high since water molecules have a stable structure at ambient temperature. The following reactions occur in standard water electrolysis:

at anode: 2H₂O→4H⁺+4e̅+O₂ (1)

at cathode: 4H⁺+4e̅→2H₂ (2)

Overall reaction: 2H₂O→2H₂+O₂ E₀=+1.23 V (3)

The hydrogen evolution reaction (HER) at the cathode is a two electron-proton reaction, and the oxygen evolution reaction (OER) at the anode is a multi-electron transferring process, involving several intermediates and the removal of four protons per oxygen molecule evolved. The complexity of the OER requires a large overpotential, even with state-of-the-art catalysts and especially when compared to the HER (“Electrolysis of low-grade and saline surface water”, Tong et al, Nature Research, Springer Nature, 2020).

In the SDE electrolyzer, hydrogen gas is still produced at the cathode, but at the anode, SO₂ is oxidized to SO₃, which combines with water to form sulfuric acid:

At anode: SO_{2(aq)}+2H₂O→4H⁺+2e̅+SO₄²⁻_{(aq)} (4)

At cathode: 2H⁺+2e̅→H_{2(g)} (5)

Overall reaction: SO_{2(aq)}+2H₂O→H₂SO_{4(aq)}+H_{2(g)} E₀=+0.158 V (6)

The advantage of the SDE process is that SO₂ oxidation occurs at a much lower voltage than water electrolysis. The standard reversible voltage E₀ of the net cell reaction is only 0.158 V (Gorensek, Staser, Stanford and Weidner 2009), versus the E₀=1.23 V needed in conventional water electrolysis. Practical SDE cell voltages are 0.45 to 0.60 V versus 1.8 V to 2.6 V in conventional water electrolysis.

By definition, SO₂ depolarized electrolysis ceases when oxygen evolution starts (i.e. the process taking place is then normal electrolysis of water).

Different aspects of SDE electrolyzer design and electrolysis process have been described in U.S. Pat. Nos. 4,306,950, 4,412,895, 4,460,444, and 7,261,874, and U.S. Pat. Appl. Pub. No. 2007/0007147 to Westinghouse Electric Corp., as well as in patents and patent applications to others such as Japanese Pat. No. 2008-223098, PCT. Pat. Appl. Pub. Nos. WO/2013191402 and WO/2009026640, and U.S. Pat. Appl. No. 2009/0045073. A Hybrid Sulfur Cycle (HyS) and an SDE electrolyzer design are disclosed in U.S. Pat. No. 8,956,526.

The main disadvantage of the methods and SDE electrolyzer designs disclosed in the above-mentioned patents is that the corrosive feed/electrolyte solution used in the electrochemical cell leads to major design challenges. Concentrated sulfuric acid is a very weak acid and a poor electrolyte but in the dilute state, it is a strong acid that will corrode most materials. The formation of sulfuric acid during electrolysis leads to material selection problems that need to be overcome to make the process economical and efficient.

U.S. Pat. No. 11,230,771 discloses a method and apparatus for electrochemical treatment of an aqueous solution containing an acidic sulfur-containing gas (e.g. H₂S or SO₂) and an absorbent (e.g. an alkanolamine) in which the sulfur-containing gas is oxidized (e.g. to elemental sulfur or HₓSO_{y}ⁿ⁻) with co-production of H₂ gas (e.g. from H₂O or H₂S). The main disadvantage of the method is that it requires the presence of an additional absorbent along with the need for its subsequent regeneration from the reaction products, which increases the material and operational costs of the process.

At the same time, seawater itself is sufficiently conductive to function as an electrolyte to conduct electricity. The presence of more than 70 constituents of dissolved salts in sea water, mainly sodium (Na⁺), chloride (Cl⁻), sulfate (SO₄²⁻), magnesium (Mg²⁺), calcium (Ca²⁺) and potassium (K⁺) make sea water an excellent conductor (“Water Electrolysis”, Badea et al, University of Oradea, 2007). Seawater is potentially an endless source of water for electrochemical generation of hydrogen.

Seawater could be electrolyzed to produce hydrogen at the cathode and either chlorine or oxygen at the anode. At present, direct seawater electrolysis has been used commercially for reducing organic fouling in process cooling water, for disinfecting sewage streams, and for sterilizing water used in pressure injection in oil and gas formations. The electrolysis of seawater generally follows one of three primary pathways:
1) Electrolysis to produce hydrogen, oxygen and alkalis;
2) Electrolysis to produce hydrogen, oxygen, chlorine and alkalis;
3) Electrolysis to produce hydrogen and sodium hypochlorite (NaOCl).

The second pathway seems to be the most dominant, however (Badea et al 2007). The main challenges in practical application of seawater electrolysis thus include:
the production of toxic chlorine gas and corrosion at the anode of the cell;
the precipitation of magnesium hydroxide and calcium carbonate at the cathode;
the low conductivity of the electrolyte and subsequent high power requirements.

It has been demonstrated in the prior art that sulfur can be oxidized electrochemically in water producing sulfuric acid and hydrogen, preventing O₂ evolution (M. Mohammad et al. “Prospects of Sea Water Electrolysis for the Production of Hydrogen: An Exploratory Study on the Electrolysis of Magnesium Chloride Solution in the Presence of Sulfur”, J. Chem. Soc. Pak., Vol. 33, 2011). The presence of sulfur is known to prevent the evolution of chlorine gas and precipitation of magnesium hydroxide in seawater electrolysis, most probably through the formation of sulfuric acid. While water gets electro-oxidized at potential 1.23 V vs NHE and the Chlorine Evolution Reaction occurs at potential 1.36 V vs NHE, sulfur is electrolyzed at 0.45 V vs NHE. If seawater is electrolyzed with sulfur powder in the anode compartment or with a “sulfur electrode,” then chlorine evolution may be prevented and, the generated H⁺ traveling to the cathode (compartment) will prevent Mg(OH)₂ precipitation, maintaining conditions of pH<7.0.

Thus, a more cost-effective flue gas desulfurization process that answers the challenges described above remains a long-felt, yet unmet need.

### BRIEF SUMMARY OF THE INVENTION

The invention disclosed herein is designed to meet this need. A method and apparatus for electrochemical production of hydrogen from saline water containing sulfur dioxide and/or bisulfite, in which the sulfur dioxide and/or bisulfite acts as an anode depolarizer, is disclosed. In some embodiments of the invention, the electrochemical production of hydrogen is combined with a process for removal of sulfur from flue gas by use of a seawater-based scrubber. The invention discloses an electrochemical method of Sulfur Dioxide Depolarized Seawater Electrolysis (Seawater SDE) in which a sulfur dioxide rich feed/electrolyte solution comprising saline water such as seawater and sulfur dioxide, a sulfur dioxide derivative, bisulfite, a substance that can react to product sulfur dioxide or bisulfite, or a combination thereof, is introduced into an electrochemical cell in which hydrogen is produced by electrochemical reduction of water and sulfur dioxide and/or bisulfite acts as an anode depolarizer and is oxidized to sulfate ions (SO₄²⁻).

In the Seawater SDE process, the oxidation of SO₂ and/or bisulfite occurs at a much lower voltage than the oxygen evolution reaction (OER) in conventional water electrolysis. The standard reversible voltage E₀ of the net cell reaction is only 0.158 V, versus the E₀=1.23 V needed in conventional water electrolysis. The operational conditions of the Seawater SDE are in the acidic and slightly acidic regions with pH in the range from 3-5.5 at the SO₂ absorption step and up to 6.5 after electrolysis step.

The low voltage and pH conditions of the Sulfur Dioxide Depolarized Seawater Electrolysis process overcome the main challenges to efficient and cost-effective seawater electrolysis known in the art; chlorine evolution is avoided, and precipitation of magnesium hydroxide (Mg(OH)₂) and calcium carbonate (CaCO₃) at the cathode are prevented as well.

The absorbed SO₂ and/or HSO₃⁻ is oxidized to SO₄²⁻. Since sulfate is nontoxic, the reaction products can be discharged into the environment, and since sulfate is a natural constituent of seawater, in the case in which the saline water is seawater, the discharge returned to the sea will have only a slightly higher sulfate content.

Implementing the present invention provides co-production of hydrogen. The resulting hydrogen can then be used as a reagent, e.g. in hydrotreating processes in refineries and in other industries, thus providing an additional benefit to the present invention over methods known in the art. The value of the hydrogen makes the flue gas purification system described herein more economically effective.

It is a further object of this invention to disclose a method and apparatus for the direct production of hydrogen from seawater, thereby unlocking the potential for mass production of “Green hydrogen” from abundant natural resources: renewable energy and seawater, and accelerating the transition to sustainable energy. The proposed process can act to smooth grid integration of highly intermittent renewable energy sources, especially off-shore wind energy, coastal onshore wind and solar farms. Hydrogen can often be consumed in situ or “over the fence” as it is used in different industrial processes. In some cases, it may be economically feasible to transport seawater by pipeline even inland from the sea coast and back (for example, in reverse mode).

In the case of production of hydrogen gas from sulfur dioxide rich seawater, sulfur dioxide can be absorbed from flue gases or other sources, or supplied in compressed or liquefied forms or in absorbent-based storage tanks for on-site production of sulfur dioxide rich seawater. In projects for mass production of hydrogen, in cases where there is no source of technogenic SO₂ near the hydrogen production facility, SO₂ can be generated from elemental sulfur. The recovered thermal energy of this process can provide additional benefits. Alternatively, sulfur dioxide rich seawater can be produced with use of chemical compounds such as sulfites, bisulfites, metabisulfites and other derivatives of sulfur dioxide; or from sulfates present in seawater, for example, by concentration sulfates in electrodialysis and/or osmosis nano-filtration, and then reducing sulfates to hydrogen sulfide in bioreactor with sulfur reducing bacteria and following oxidation of H₂S to sulfur dioxide.

In contrast to U.S. Pat. No. 11,230,771, which describes a method and apparatus for electrochemical treatment of sulfur-containing gas (e.g. H₂S or SO₂) supplied in solution with an absorbent (e.g. an alkanolamine), the invention disclosed herein describes a method and apparatus for electrochemical treatment of saline water in the presence of SO₂ and/or bisulfite that does not require the presence of an additional absorbent, thereby saving material costs both for the process itself and for the apparatus on which the process is performed. In preferred embodiments of the invention, the invention disclosed herein does not use or require the presence of any added alkanolamine-containing absorbent. In more preferred embodiments of the invention, the invention does not require the use or presence of any added organic absorbent. In yet more preferred embodiments of the invention, the invention does not require the use or presence of any added absorbent whatsoever. In particularly preferred embodiments of the invention, the invention disclosed herein does not use or require the presence of any absorbent whatsoever, and is performed in the absence of any absorbent.

In addition, in the process disclosed herein, there is no need for downstream regeneration of an absorbent from products of the reaction. As described above, seawater is particularly suitable for absorption of SO₂ from flue gases and then can be returned to the sea, without detrimental effects on the environment. Other advantages of the invention disclosed herein are operational conditions of the Seawater SDE with pH in the acidic and slightly acidic regions, compared to absorbent-based processes known in the art, which generally are performed under more basic conditions. The favorable pH conditions of the Seawater SDE process for proton-exchange membranes (PEMs, which are acidic by nature) permits use of the promising PEM configuration (e.g. based on commercially available chemical resistant reinforced PEM membranes). The use of PEM configuration in seawater electrolysis can protect the cathode from impurities by acting as a filtration barrier.

Compared to sulfur enhanced seawater electrolysis process disclosed in the prior art (M. Mohammad et al.), in the Seawater SDE electrolyzer of the present invention, SO₂ oxidation occurs at a lower voltage than sulfur oxidation. SO₂ oxidation reaction takes place at potential 0.158 V, in contrast to sulfur electrolysis, which takes place at 0.45 V vs NHE. Thus, Seawater SDE is a more efficient process compared to seawater electrolysis in the presence of sulfur.

It is therefore an object of the present invention to disclose a method for production of hydrogen gas from sulfur dioxide rich saline water comprising at least one inorganic species that comprises or can produce sulfur dioxide or bisulfite ions, wherein said method comprises:
providing at least one electrochemical cell, said electrochemical cell comprising (a) at least one positive electrode (anode) and one negative electrode (cathode); (b) solution supply means adapted to supply a feed/electrolyte solution to said electrochemical cell; (c) solution withdrawal means adapted to withdraw a feed/electrolyte solution from said electrochemical cell; (d) product withdrawal means for withdrawing from said electrochemical cell products of electrochemical reactions occurring within said electrochemical cell; and (e) electrical connecting means configured to provide external electrical connections to at least one of said positive electrode and said negative electrode;
obtaining sulfur dioxide rich saline water;
supplying to said electrochemical cell a feed/electrolyte solution comprising said sulfur dioxide rich saline water;
connecting said electrochemical cell to an external power supply so as to cause within said electrochemical cell an electrochemical reaction that produces hydrogen gas; and
removing said electrochemically produced hydrogen gas from said electrochemical cell.

It is within the essence of the invention that said at least one inorganic species that comprises or can produce sulfur dioxide or bisulfite ions acts as an anode depolarizer.

It is a further object of this invention to disclose such a method, wherein said saline water comprises saline water selected from the group consisting of seawater and brackish water.

It is a further object of this invention to disclose the method as defined in any of the above, wherein said step of obtaining sulfur dioxide rich saline water comprises obtaining sulfur dioxide rich saline water comprising at least one component selected from the group consisting of sulfur dioxide, sulfite, bisulfite, metabisulfite, and salts and conjugate acids of sulfite, bisulfite, and metabisulfite.

It is a further object of this invention to disclose the method as defined in any of the above, wherein said step of obtaining sulfur dioxide rich saline water comprises obtaining sulfur dioxide rich saline water produced from saline water and sulfur dioxide gas obtained from a source selected from the group consisting of flue gas and tail gas.

It is a further object of this invention to disclose the method as defined in any of the above, wherein said step of obtaining sulfur dioxide rich saline water comprises obtaining sulfur dioxide rich saline water produced from saline water and sulfur dioxide generated from elemental sulfur.

It is a further object of this invention to disclose the method as defined in any of the above, wherein said step of obtaining sulfur dioxide rich saline water comprises obtaining sulfur dioxide rich saline water produced from saline water and sulfur dioxide supplied in a form selected from the group consisting of compressed sulfur dioxide gas, liquefied sulfur dioxide, and sulfur dioxide gas stored in an absorbent-based storage tank.

It is a further object of this invention to disclose the method as defined in any of the above, wherein said step of obtaining sulfur dioxide rich saline water comprises obtaining sulfur dioxide rich saline water produced from saline water and sulfur dioxide obtained by adding at least one sulfur dioxide derivative to saline water. In some preferred embodiments of the invention, said step of obtaining sulfur dioxide rich saline water produced from saline water and sulfur dioxide derivatives comprises adding at least one sulfur dioxide derivative to saline water and further wherein said sulfur dioxide derivative comprises at least one sulfur dioxide derivative selected from the group consisting of sulfites, bisulfites, and metabisulfites. In some especially preferred embodiments of the invention, said at least one sulfur dioxide derivative is selected from the group consisting of sodium sulfite, potassium sulfite, sodium bisulfite, potassium bisulfite, sodium metabisulfite, and potassium metabisulfite.

It is a further object of this invention to disclose the method as defined in any of the above, wherein said step of obtaining sulfur dioxide rich saline water comprises producing sulfur dioxide rich saline water from saline water and sulfur dioxide produced from sulfate. In some preferred embodiments of the invention, said sulfur dioxide is produced from sulfate naturally occurring in said saline water. In some preferred embodiments of the invention, said sulfur dioxide is produced by a method comprising: (a) concentrating said sulfate by a method selected from the group consisting of electrodialysis and osmosis nano-filtration; (b) reducing said sulfate to H₂S in a bioreactor containing sulfur reducing bacteria; and, (c) oxidizing said H₂S to sulfur dioxide.

It is a further object of this invention to disclose the method as defined in any of the above, wherein: (a) said electrochemical cell comprises a separator that divides said cell into an anode compartment in electrical connection with said anode and a cathode compartment in electrical connection with said cathode; and, (b) said solution supply means and said solution withdrawal means are in fluid connection with said anode compartment but are not in fluid connection with said cathode compartment.

In some preferred embodiments of the method disclosed herein in which said electrochemical cell comprises a separator, said separator is a proton-conductive separator. In some preferred embodiments of the method disclosed herein in which said electrochemical cell comprises a separator, said separator is an anion-conductive separator.

It is a further object of this invention to disclose the method as defined in any of the above in which said separator is a proton-conductive separator, wherein said proton-conductive separator comprises at least one catalyst layer, said at least one catalyst layer selected from the group consisting of anode-side catalyst layers disposed on at least a part of said anode side of said separator and cathode-side catalyst layers disposed on at least a part of said cathode side of said separator. In some embodiments of the method, said proton-conductive separator comprises at least one anode-side catalyst layer comprising a catalyst selected from the group consisting of graphite, glassy carbon, lead dioxide, mixed aluminum-vanadium oxides on carbon, gold, silver, platinum, aluminum-doped platinum, ruthenium, palladium, rhodium, tantalum, niobium, molybdenum, tungsten (wolfram), iridium, osmium, and mixtures thereof. In some embodiments of the method, said proton-conductive separator comprises at least one cathode-side catalyst layer comprising a catalyst comprising at least one component selected from the group consisting of: (a) metal oxides; and (b) gold, nickel, molybdenum, platinum, ruthenium, palladium, iridium, zirconium, aluminum, lead, sulfides thereof, and alloys thereof. In some preferred embodiments of the method, said proton-conductive separator comprises a cathode-side catalyst layer comprising a catalyst comprising a metal oxide selected from the group consisting of oxides of palladium, ruthenium, iridium, zirconium, aluminum, and lead; SnO₂; SbO₂; TaO₂; TiO₂; and Ti₄O₇.

It is a further object of this invention to disclose the method as defined in any of the above in which said separator is an anion-conductive separator, wherein said anion-conductive separator comprises at least one component selected from the group consisting of anion exchange membranes and catalyst layers. In some embodiments of the invention, said anion-conductive separator comprises at least one catalyst layer selected from the group consisting of anode-side catalyst layers and cathode-side catalyst layers.

It is a further object of this invention to disclose the method as defined in any of the above, wherein said step of providing at least one electrochemical cell comprises providing a plurality of electrochemical cells connected in series.

It is a further object of this invention to disclose an electrochemical cell for production of hydrogen from seawater in the presence of sulfur dioxide as an anode depolarizer, wherein said cell comprises:
at least one positive electrode (anode) and one negative electrode (cathode);
a feed/electrolyte solution comprising sulfur dioxide rich saline water;
solution supply means for supplying said feed/electrolyte solution to said electrochemical cell;
solution withdrawal means for withdrawing said feed/electrolyte solution from said electrochemical cell;
product withdrawal means for withdrawing from said electrochemical cell products of electrochemical reactions occurring within said electrochemical cell; and,
electrical connecting means configured to provide external electrical connections to at least one of said positive electrode and said negative electrode;
wherein said feed/electrolyte solution does not comprise any added alkanolamine absorbent.

In some preferred embodiments of the invention, said feed/electrolyte solution does not comprise any added organic absorbent. In some especially preferred embodiments of the invention, said feed/electrolyte solution does not comprise any added absorbent whatsoever.

It is a further object of this invention to disclose the electrochemical cell as defined above, wherein said electrochemical cell comprises circulating means configured to circulate feed/electrolyte solution through said electrochemical cell.

It is a further object of this invention to disclose the electrochemical cell as defined in any of the above, wherein: said electrochemical cell comprises a conductive separator that divides said cell into an anode compartment in electrical connection with said anode and a cathode compartment in electrical connection with said cathode; and, said solution supply and withdrawal means are in fluid connection with said anode compartment but are not in fluid connection with said cathode compartment.

In some embodiments of the electrochemical cell disclosed herein in which the electrochemical cell comprises a conductive separator, said separator is a proton-conductive separator. In some embodiments of the electrochemical cell disclosed herein in which the electrochemical cell comprises a conductive separator, said separator is an anion-conductive separator.

It is a further object of this invention to disclose the electrochemical cell as defined in any of the above in which said electrochemical cell comprises a proton-conductive separator, wherein said proton-conductive separator comprises at least one component selected from the group consisting of proton-conductive membranes and catalyst layers. In some embodiments of the electrochemical cell in which said proton-conductive separator comprises at least one catalyst layer, said at least one catalyst layer is selected from the group consisting of anode-side catalyst layers disposed on at least a part of said anode side of said separator and cathode-side catalyst layers disposed on at least a part of said cathode side of said separator. In some embodiments of the electrochemical cell in which said proton-conductive separator comprises at least one anode-side catalyst layer, said at least one anode-side catalyst layer comprises a catalyst selected from the group consisting of graphite, glassy carbon, lead dioxide, mixed aluminum-vanadium oxides on carbon, gold, silver, platinum, aluminum-doped platinum, ruthenium, palladium, rhodium, tantalum, niobium, molybdenum, tungsten (wolfram), iridium, osmium, and mixtures thereof. In some embodiments of the electrochemical cell in which said proton-conductive separator comprises at least one cathode-side catalyst layer, said cathode-side catalyst layer comprises a catalyst that comprises at least one component selected from the group consisting of: (a) metal oxides; and, (b) gold, nickel, molybdenum, platinum, ruthenium, palladium, iridium, aluminum, lead, sulfides thereof, and alloys thereof. In some preferred embodiments of the electrochemical cell, said proton-conductive separator comprises a cathode-side catalyst layer comprising a catalyst comprising a metal oxide, wherein said metal oxide is selected from the group consisting of oxides of palladium, ruthenium, iridium, zirconium, aluminum, lead; SnO₂; SbO₂; TaO₂; TiO₂; and Ti₄O₇.

In some embodiments of the electrochemical cell disclosed herein in which said electrochemical cell comprises an anion-conductive separator, said anion-conductive separator comprises at least one component selected from the group consisting of anion exchange membranes and catalyst layers. In some particularly preferred embodiments of the invention, said anion-conductive separator comprises at least one catalyst layer selected from the group consisting of anode-side catalyst layers disposed on at least a part of said anode side of said separator and cathode-side catalyst layers disposed on at least a part of said cathode side of said separator.

### BRIEF DESCRIPTION OF THE DRAWING

The invention will now be described with reference to the drawing, wherein:

FIG. 1 shows a simplified schematic diagram of one embodiment of an apparatus for electrochemical production of hydrogen from sulfur dioxide rich seawater, comprising an electrochemical cell (electrolyzer) with a proton conductive membrane separating the electrodes.

### DETAILED DESCRIPTION OF PREFERRED EMBODIMENTS

The following description of certain exemplary embodiments of the invention is given to explain the principles of the invention and its practical applicability in order that a person of ordinary skill will be able to make and use the invention. The embodiments disclosed in the following description are not intended to be limiting. The invention disclosed herein is thus not defined by the particular embodiments described in the specification, but by the claims, and only by the broadest interpretation of said claims. In addition, while in some cases, for clarity, individual components, method steps, or specific combinations thereof, are described, all combinations of components or method steps disclosed in the specification that are not self-contradictory are considered by the inventor to be within the scope of the invention.

In all cases in which an embodiment of the invention is described as “comprising” a set of components or method steps, i.e., the invention may include components or method steps in addition to those explicitly listed, the scope of the invention is to be understood to include embodiments in which the invention “consists of” the listed components or method steps, i.e., embodiments that include the listed components or method steps and no others, and to include as well embodiments in which the invention “consists essentially of” the listed components or method steps, i.e., embodiments that do not include any components or method steps not listed that would materially affect the basic an novel characteristics of the invention.

All prior art documents cited herein are incorporated by reference in their entirety.

With reference to electrical connections to an electrochemical cell, as used herein, the term “electrical connections from an external power supply” refers to any connection that places at least part of the electrochemical cell in electrical contact with a physical body or a circuit that is located partially or entirely outside of the electrochemical cell.

As used herein, with respect to an electrochemical cell, the term “positive electrode” refers to the anode and the term “negative electrode” refers to the cathode.

The invention disclosed herein provides a method and system for electrochemical production of hydrogen gas from saline water in the presence of sulfur dioxide or bisulfite and for electrochemical purification of sulfur dioxide-containing tail (or flue) gases. In the following description, in many cases, the method and system disclosed herein are described in terms of preferred embodiments in which the saline water is seawater. Nonetheless, as a person of ordinary skill in the art will readily appreciate, the method and system disclosed herein can be used with saline water from any source. Therefore, embodiments of the invention that use saline water other than seawater are considered by the inventor to be within the scope of the invention.

As used herein, the term “sulfur dioxide rich” is used to refer to seawater or other saline water that comprises at least one inorganic species that comprises or can produce sulfur dioxide or bisulfite ions in a concentration higher than its naturally occurring level. Non-limiting examples of inorganic species that may be present in sulfur dioxide rich seawater or saline water include sulfur dioxide, sulfites, bisulfites, metabisulfites, and salts and conjugate acids of sulfites, bisulfites, and metabisulfites.

In sulfur dioxide Depolarized Seawater Electrolysis (Seawater SDE) the reaction is carried out in an electrochemical cell (electrolyzer) where hydrogen is electrochemically produced by reduction of water in the presence of sulfur dioxide or bisulfite as an anode depolarizer and the anode depolarizer is oxidized to sulfate ions (SO₄²⁻), a natural constituent of seawater.

In aqueous solution, dissolved SO₂ undergoes reversible hydration and ionization, eqs (7) and (8):

SO_{2(g)}↔SO_{2(aq)} (7)

SO_{2(aq)}+H₂O₍ₗ₎↔HSO₃⁻+H⁺ (8)

When SO₂ is dissolved in water, it may dissociate to some extent depending on its concentration, the presence of other ions and the pH of the solution. Dissociation affects the solubility of SO₂. When the external pressure exceeds the vapor pressure of SO₂, a liquid SO₂ phase is formed due to the miscibility gap in the SO₂—H₂O system. The solubility of SO₂ is lower in low concentrations of sulfuric acid than in pure water. This is explained by the effect of H⁺ ions on the dissociation or hydrolysis of sulfur dioxide. When the concentration of sulfuric acid is increased, the solubility behavior of SO₂ can be described as physical solubility, while in less acidic (or alkaline) solutions the solubility is enhanced by the “chemical solubility” caused by hydrolysis reactions or chemical reactions with other possible species present in the solution (“Fundamentals of SO₂ depolarized water electrolysis and challenges of materials used”, A. Lokkiluoto, Aalto University, 2013).

As SO₂ is an acidic gas, an increase of the pH of the solution is favorable to its absorption. Seawater is alkaline by nature (with typical pH of 7.6-8.4) due primarily to the presence of bicarbonates, thus it is suitable for absorption of SO₂. Bicarbonate ions (HCO₃⁻) present in the seawater react with the hydrogen ions (H⁺) produced during hydrolysis of SO₂, thereby reducing the acidic effect of absorbed SO₂.

Without wishing to be bound by theory, when a feed/electrolyte solution comprising sulfur dioxide rich seawater is placed in an electrochemical cell which is then connected to an external power source, hydrogen gas will be generated at the cathode and the dissolved sulfur dioxide (SO₂) and bisulfite (HSO₃⁻) ions will be oxidized to sulfate ions (SO₄²⁻) at the anode, eqs (9)-(12).

At anode: SO_{2(aq)}+2H₂O→4H⁺+2e̅+SO₄²⁻_{(aq)} (9)

HSO₃⁻+H⁺+H₂O→4H⁺+2e̅+SO₄²⁻_{(aq)} (10)

At cathode: 2H⁺+2e̅→H_{2(g)} (11)

Overall reaction: SO_{2(aq)}+2H₂O→2H⁺+SO₄²⁻_{(aq)}+H_{2(g)} (12)

### (Electrochemical)

Since the alkalinity of seawater will tend to drive eq (8) to the right, when the process is performed using sulfur dioxide rich seawater, it is expected that in seawater, the reaction will proceed primarily via oxidation of bisulfite, eq (10). Conversely, under acidic conditions, eq (8) will be driven to the left, and it is expected that in acidic saline water, the inventive process will proceed primarily via oxidation of SO₂, eq (9). Of course, under most reaction conditions, both SO₂ and HSO₃⁻ will both be present to some extent, so the existence of one of eqs (9) or (10) as a primary pathway does not exclude simultaneous production of sulfate via both pathways.

In addition, it is noted that since hydrolysis of sulfur dioxide will in any case form bisulfite, and electrochemical oxidation of bisulfite to sulfate will occur under the operating conditions of the instant invention, embodiments of the invention in which the sulfur dioxide rich saline water comprises bisulfite are considered by the inventor to be within the scope of the invention. The bisulfite-containing sulfur dioxide rich saline water can be obtained by direct addition of a soluble bisulfite salt to saline water, or via chemical reaction of a species that can react (e.g., by hydrolysis) to form bisulfite.

As another non-limiting example, it is well known in the art that metabisulfite undergoes hydrolysis in water to form bisulfite ions, eq (13):

S₂O₅²⁻+H₂O→2HSO₃⁻ (13)

Since, as explained above, any substance that can produce bisulfite can be used to produce sulfur dioxide rich water in which SO₂ and/or HSO₃⁻ acts as an anode depolarizer, embodiments of the invention in which the sulfur dioxide rich saline water comprises metabisulfite are also considered by the inventor to be within the scope of the invention.

The preceding examples are given solely to enable a person of ordinary skill in the art to make and use the instant invention, and are not intended to limit the invention in any way. Indeed, from the preceding discussion, it will be clear to a person of ordinary skill in the art that the method disclosed herein that sulfur dioxide rich water containing SO₂ or HSO₃⁻ can provide the SO₂/HSO₃⁻ anode depolarizer, no matter whether the sulfur dioxide or bisulfite is added directly or produced via chemical reaction.

In the Seawater SDE process, the oxidation of SO₂/HSO₃⁻ occurs at a much lower voltage than the oxygen evolution reaction (OER) in conventional water electrolysis. The standard reversible voltage E₀ of the net cell reaction is only 0.158 V, versus the E₀=1.23 V needed in conventional water electrolysis. Practical SDE cell voltages are 0.45 to 0.60 V versus 1.8 V to 2.6 V in conventional water electrolysis. (Gorensek et al).

Direct seawater electrolysis processes known in the art face significant technical challenges such as evolution of chlorine gas and blocking of the cathode by precipitation of materials such as magnesium hydroxide (Mg(OH)₂) and calcium carbonate (CaCO₃). Evolution of free chlorine occurs at potential close to 1.4 V vs SHE. Precipitation of Mg(OH)₂ occurs at pH≥˜9.5 (Tong et al.), while precipitation of CaCO₃ occurs at pH≥10.3 @ 25° C. (“PH Buffering in Aquifers”, Enviro Wiki). The operational conditions of the Seawater SDE are in the acidic and slightly acidic regions with pH in the range from 3-5.5 at the SO₂ absorption step and up to 6.5 after electrolysis step. Thus, evolution of chlorine gas and precipitation of Mg(OH)₂ and CaCO₃ are suppressed or prevented entirely under the low voltage and acidic pH conditions of the Seawater SDE process disclosed herein.

In various embodiments, the direct Seawater SDE process disclosed herein can be performed either as acidic electrolysis in which hydrogen ions (H⁺) act as charge carriers, or as alkaline electrolysis in which hydroxide ions (OH⁻) act as charge carriers. The acidic pathway is preferred in the case of bulk electrolysis of SO₂-rich seawater or with the use of a two-compartment electrochemical cell with a Proton Exchange Membrane (PEM) serving as a separator and proton transport medium. The alkaline electrolysis pathway is preferred in the case of a two-compartment electrochemical cell with an Anion Exchange Membrane (AEM) as a separator.

Embodiments that incorporate alternate designs for the apparatus for performance of the Seawater SDE disclosed herein are considered by the inventor to be within the scope of the invention. Non-limiting examples include liquid electrolyte electrolyzers and Proton Exchange Membrane (PEM) electrolyzers that have been developed for water electrolysis applications. A membrane electrode assembly (MEA) of the PEM electrolyzer provides both the reaction interface and the ion migration route; in addition, it provides a good surface for electron dispersal away from the reaction interface. The PEM electrolyzer includes a membrane that will let hydrogen ions (protons) pass through but stop hydrogen gas from flowing through. The membrane is also intended to prevent other chemical species from migrating between electrodes and undergoing undesired reactions that could poison the cathode or reduce overall process efficiency (e.g. it will prevent reduction of SO₂ at the cathode).

It is within the scope of the invention to disclose a process for water electrolysis using SO₂ rich seawater (the Seawater SDE process).

In typical non-limiting embodiments of the process, a feed/electrolyte solution comprising sulfur dioxide rich seawater is introduced into an electrochemical cell. The electrochemical cell is attached to an external energy source, thereby causing an electrochemical reaction to take place within the cell that generates hydrogen gas and sulfate ions (SO₄²⁻).

The feed/electrolyte solution may be prepared by any method known in the art. The feed/electrolyte solution may be prepared, for example, directly from a source of sulfur dioxide gas and seawater. In some non-limiting embodiments of the invention, the sulfur dioxide gas is obtained from flue gases. While any means known in the art can be used to separate sulfur dioxide from the flue gas, in preferred embodiments of the invention, a flue gas stream is passed through a seawater scrubber or column containing a seawater under appropriate conditions of temperature and pressure. Sulfur dioxide gas is preferentially absorbed by seawater and is thereby at least partially removed from the flue gas stream. A purified gas stream exits the column, and the remaining solution, comprising sulfur dioxide rich seawater, is removed from the column and used as the feed/electrolyte solution. The method and system disclosed herein can thus be integrated into a system for removing sulfur dioxide from flue gas.

In some non-limiting embodiments of the invention, said sulfur dioxide is produced in-situ from elemental sulfur, or supplied in compressed, liquefied forms, or in absorbent-based storage tanks for on-site production of sulfur dioxide rich seawater.

In some non-limiting embodiments of the invention, the SO₂ from which the sulfur dioxide rich seawater is produced from sulfate species. It can be produced from sulfates naturally present in the seawater by any method known in the art. As a non-limiting example, the sulfur dioxide can be produced from sulfates by concentrating sulfates in the solution by electrodialysis and/or osmosis nano-filtration, reducing sulfates to hydrogen sulfide in bioreactor with sulfur reducing bacteria and the oxidizing the H₂S to sulfur dioxide.

In some embodiments of the invention, the sulfur dioxide rich saline water is produced by addition of one or more SO₂ derivatives to saline water. Typical compounds that can be used to produce SO₂-rich saline water include, but are not limited to, sulfites, bisulfites, and metabisulfites. Non-limiting examples of sulfites, bisulfites, and metabisulfites that can be used to produce SO₂-rich seawater include sodium sulfite, potassium sulfite, sodium bisulfite, potassium bisulfite, sodium metabisulfite, potassium metabisulfite. These compounds can be added by any convenient method, and in different non-limiting embodiments, may be added in the form of solids or as aqueous solutions.

In some embodiments of the invention, saline water derived from other sources is used in the process instead of seawater. In some embodiments of the invention, this saline water is derived from brackish water such as brackish groundwater from saline aquifers. The water exiting the electrochemical cell after the electrolysis process can be used as a source of water for irrigation. The use of this water can be particularly beneficial for this use, as it supplies sulfur nutrients in a sulfate form that is immediately available to plants uptake.

It is also within the scope of the invention to disclose an electrochemical cell (electrolyzer) for electrolysis of SO₂-rich saline water.

In preferred embodiments, the electrochemical cell comprises at least two electrodes connected to an external power supply; in different electrochemical cell designs the electrodes can be separated by: a feed/electrolyte solution; or by a proton conductive separator; or by an anion-conductive separator. It is also necessary to ensure supply of the feed/electrolyte solution to the electrochemical cell and withdrawal of the regenerated solution and products of the electrochemical reaction from the cell.

In some embodiments of the invention, said proton conductive separator is a proton-conductive membrane (PEM).

In some embodiments of the invention, said anion-conductive separator is an anion exchange membrane (AEM).

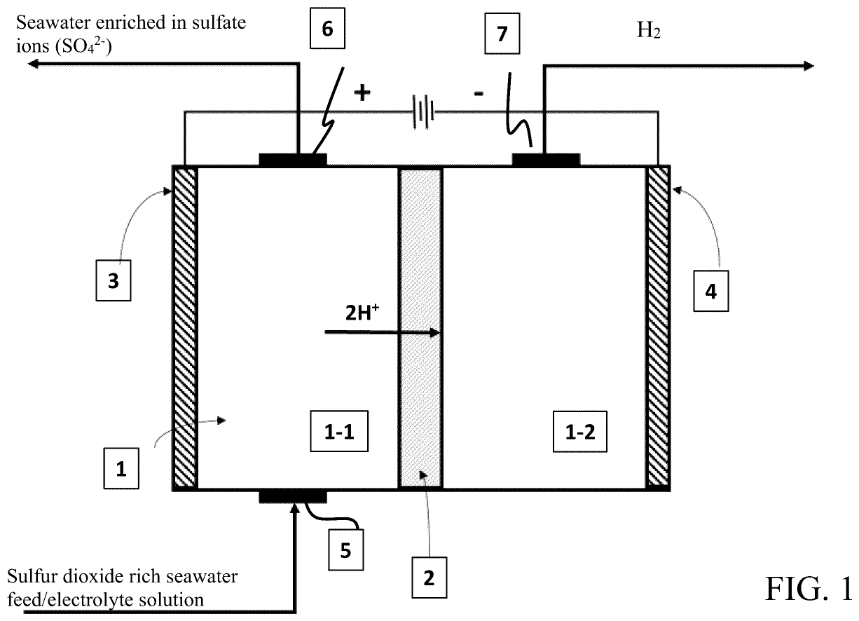

Reference is now made to FIG. 1, which illustrates a non-limiting embodiment of an electrochemical cell for production of hydrogen from saline water in which SO₂ or HSO₃⁻ acts as an anode depolarizer according to the present invention. In this embodiment, the electrochemical cell comprises a frame (1); a proton exchange membrane (PEM) (2); a positive electrode (anode) (3) and a negative electrode (cathode) (4). Each of the anode 3 and the cathode 4 typically consists of an electrically-conductive structure, and when the cell is in use, both are connected to an external power supply. In the embodiment shown, one PEM membrane is used; in other embodiments, a plurality of membranes may be used, or the anode and cathode can be separated by the feed/electrolyte solution. The PEM membrane can be made from polymeric, ceramic or other specially elaborated and composite materials, such as Nafion, Polybenzimidazole, Sulfornated Polybenzimidazole (s-PBI), Sulfonated Diels-Alder Polyphenylene, Sulfonated PFCB-BPVE-Tetramer, Hybrid Silica-Nafion nanocomposites etc., which let hydrogen ions (protons) pass through membrane but stop hydrogen gas and other compounds. PEM 2 divides the interior of frame 1 into an anode chamber (1-1) and a cathode chamber (1-2). Anode chamber 1-1 includes an inlet (5) and an outlet (6), and cathode chamber 1-2 includes an outlet (7). In operating mode, inlet 5 is used to admit sulfur dioxide rich seawater into anode chamber 1-1, and outlet 6 is used to remove the feed/electrolyte solution containing the reaction products described above from the anode chamber 1-1. Hydrogen gas generated at the cathode exits the cathode chamber via outlet 7. In embodiments of the invention in which the cathode and the anode are separated by the feed/electrolyte solution, there will not be separate anode and cathode chambers.

In some non-limiting embodiments of the invention in which the electrochemical cell comprises a separator, the separator (e.g. a PEM or AEM) comprises at least one catalyst layer that incorporates a catalyst. The catalyst layer may be an “anode-side” catalyst layer located or disposed on part or all of the anode side of the separator, or a “cathode-side” catalyst layer located or disposed on part or all of the cathode side of the separator. Such membranes and catalysts are well-known in the art, and may be applied to the desired side of the separator by any method known in the art. These catalysts can influence the cell voltage for the electrolysis, thereby enhancing the efficiency of the process, and can also favorably affect the stable operation of the cell. The separator may include more than one catalyst layer, and the anode and cathode sides of the separator may incorporate different catalysts.

In some non-limiting preferred embodiments, the separator comprises an anode-side catalyst. Non-limiting examples of anode-side catalysts include graphite; glassy carbon; lead dioxide; mixed aluminum-vanadium oxides on carbon; and gold, silver, platinum, aluminum-doped platinum, ruthenium, palladium, rhodium, tantalum, niobium, molybdenum, tungsten (wolfram), iridium, osmium, and mixtures and alloys thereof.

In some non-limiting preferred embodiments, the separator comprises a cathode-side catalyst. Non-limiting examples of cathode-side catalysts include metal oxides as well as metal catalysts such as gold, nickel, molybdenum, platinum, ruthenium, palladium, iridium, zirconium, aluminum, lead, and sulfides, mixtures, combinations, and alloys thereof. In some preferred embodiments of the invention, the catalyst comprises a metal oxide selected from the group consisting of oxides of palladium, ruthenium, iridium, zirconium, aluminum, lead; SnO₂; SbO₂; TaO₂; TiO₂; and Ti₄O₇.

In some embodiments of the invention, it comprises means for circulating feed/electrolyte solution through the cell. Any means known in the art (e.g. a pump with a speed and capacity appropriate for the cell) may be used. In some embodiments of the invention, the circulation means provide a fluid connection between inlet 5 and outlet 6 so that the feed/electrolyte solution is recirculated through the cell. In some embodiments of the invention, the cell includes a water supply inlet to the cathode chamber. In some embodiments, the water is used for cooling or temperature control. For simplicity and clarity, certain standard elements of electrochemical cell are not shown or described herein (for example, anode and cathode collectors, diffusion layers and catalysts which are used in order to increase the cell's capacity). A person of ordinary skill in the art will well understand the use of these standard elements in the construction of the electrochemical cell of the instant invention.

If necessary, the electrochemical cell may further comprise means for removing the product of the reaction occurring in the electrochemical cell, which are not removed by withdrawing the feed/electrolyte solution, or which occurs in the cathode chamber (in case of undesirable SO₂ crossover through the membrane), in particular, sulfur compounds.

In some embodiments of the invention, the method is performed on a system comprising a plurality (stack) of electrochemical cells connected in series. The use of a plurality of cells will enhance the overall electrolysis capability relative to the use of a single cell.

In some embodiments of the invention in which a stack of electrochemical cells is used, the feed/electrolyte solution is circulated through the system. In one non-limiting of the invention, inlet 5 of the first cell in the stack is connected to a source of feed/electrolyte system, and for each succeeding cell in the stack until the last one, outlet 6 of the cell is connected to inlet 5 of a following cell (e.g. the next cell) in the stack. The feed/electrolyte solution may be discarded from the final cell in the stack, or outlet 6 of the final cell can be connected to inlet 5 of the first cell, thereby allowing circulation of feed/electrolyte solution through the stack. If the outlet of the final cell is connected to the inlet cell, then the connection from the source of feed/electrolyte solution to the first cell can be closed after the cells in the stack are full. In embodiments that comprise a stack of electrochemical cells, any connection of the cells to a source and drain of feed/electrolyte solution, whether it permits circulation to and from any or all of them, is considered by the inventor to be within the scope of the invention.

What is claimed is:

1. A method for production of hydrogen gas from sulfur dioxide rich saline water comprising at least one inorganic species that comprises or can produce sulfur dioxide or bisulfite ions, said method comprising:
providing at least one electrochemical cell, said electrochemical cell comprising:
at least one positive electrode (anode) and one negative electrode (cathode);
solution supply means adapted to supply a feed/electrolyte solution to said electrochemical cell;
solution withdrawal means adapted to withdraw a feed/electrolyte solution from said electrochemical cell;
product withdrawal means for withdrawing from said electrochemical cell products of electrochemical reactions occurring within said electrochemical cell; and,
electrical connecting means configured to provide external electrical connections to at least one of said positive electrode and said negative electrode;
obtaining sulfur dioxide rich saline water;
supplying to said electrochemical cell a feed/electrolyte solution comprising said sulfur dioxide rich saline water;
connecting said electrochemical cell to an external power supply so as to cause within said electrochemical cell an electrochemical reaction that produces hydrogen gas; and,
removing said electrochemically produced hydrogen gas from said electrochemical cell;
wherein:
said at least one inorganic species that comprises or can produce sulfur dioxide or bisulfite ions acts as an anode depolarizer; and,
said method is performed in the absence of any added alkanolamine-containing absorbent.

2. The method according to claim 1, wherein said method is performed in the absence of any added organic absorbent.

3. The method according to claim 1, wherein said method is performed in the absence of any added absorbent.

4. The method according to claim 1, wherein said saline water comprises saline water selected from the group consisting of seawater and brackish water.

5. The method according to claim 1, wherein said step of obtaining sulfur dioxide rich saline water comprises obtaining sulfur dioxide rich saline water comprising at least one component selected from the group consisting of sulfur dioxide, sulfite, bisulfite, metabisulfite, and salts and conjugate acids of sulfite, bisulfite, and metabisulfite.

6. The method according to claim 1, wherein said step of obtaining sulfur dioxide rich saline water comprises obtaining sulfur dioxide rich saline water produced from saline water and sulfur dioxide gas obtained from a source selected from the group consisting of flue gas and tail gas.

7. The method according to claim 1, wherein said step of obtaining sulfur dioxide rich saline water comprises a step selected from the group consisting of:
obtaining sulfur dioxide rich saline water produced from saline water and sulfur dioxide generated from elemental sulfur;
obtaining sulfur dioxide rich saline water produced from saline water and sulfur dioxide supplied in a form selected from the group consisting of compressed sulfur dioxide gas, liquefied sulfur dioxide, and sulfur dioxide gas stored in an absorbent-based storage tank;
obtaining sulfur dioxide rich saline water produced from saline water and sulfur dioxide obtained by adding at least one sulfur dioxide derivative to saline water; and,
producing sulfur dioxide rich saline water from saline water and sulfur dioxide produced from sulfate.

8. The method according to claim 7, wherein said sulfur dioxide is produced by a method comprising:
concentrating sulfate naturally occurring in saline water by a method selected from the group consisting of electrodialysis and osmosis nano-filtration;
reducing said sulfate to H₂S in a bioreactor containing sulfur reducing bacteria; and,
oxidizing said H₂S to sulfur dioxide.

9. The method according to claim 1, wherein:
said electrochemical cell comprises a separator that divides said cell into an anode compartment in electrical connection with said anode and a cathode compartment in electrical connection with said cathode, said separator comprising an anode side facing said anode compartment and a cathode side facing said cathode compartment; and,
said solution supply means and said solution withdrawal means are in fluid connection with said anode compartment but are not in fluid connection with said cathode compartment.

10. The method according to claim 9, wherein said separator is a proton-conductive separator.

11. The method according to claim 10, wherein said proton-conductive separator comprises at least one catalyst layer selected from the group consisting of:
at least one anode side catalyst layer comprising a catalyst selected from the group consisting of graphite, glassy carbon, lead dioxide, mixed aluminum-vanadium oxides on carbon, gold, silver, platinum, aluminum-doped platinum, ruthenium, palladium, rhodium, tantalum, niobium, molybdenum, tungsten (wolfram), iridium, osmium, and mixtures thereof; and,
at least one cathode side catalyst layer comprising a catalyst comprising at least one component selected from the group consisting of:
metal oxides; and,
gold, nickel, molybdenum, platinum, ruthenium, palladium, iridium, zirconium, aluminum, lead, sulfides thereof, and alloys thereof.

12. The method according to claim 11, wherein said proton-conductive separator comprises a cathode side catalyst layer comprising a catalyst comprising a metal oxide selected from the group consisting of oxides of palladium, ruthenium, iridium, zirconium, aluminum, and lead; SnO₂; SbO₂; TaO₂; TiO₂; and Ti₄O₇.

13. The method according to claim 9, wherein said separator is an anion-conductive separator.

14. The method according to claim 13, wherein said anion-conductive separator comprises at least one catalyst layer selected from the group consisting of anode-side catalyst layers and cathode-side catalyst layers.

15. An electrochemical cell for production of hydrogen from saline water in the presence of sulfur dioxide as an anode depolarizer, comprising:
at least one positive electrode (anode) and one negative electrode (cathode);
a feed/electrolyte solution comprising sulfur dioxide rich saline water;
solution supply means for supplying said feed/electrolyte solution to said electrochemical cell;
solution withdrawal means for withdrawing said feed/electrolyte solution from said electrochemical cell;
product withdrawal means for withdrawing from said electrochemical cell products of electrochemical reactions occurring within said electrochemical cell; and,
electrical connecting means configured to provide external electrical connections to at least one of said positive electrode and said negative electrode;
wherein said feed/electrolyte solution does not comprise any added alkanolamine-containing absorbent.

16. The electrochemical cell according to claim 15, wherein said feed/electrolyte solution does not comprise any added organic absorbent.

17. The electrochemical cell according to claim 15, wherein said feed/electrolyte solution does not comprise any added absorbent.

18. The electrochemical cell according to claim 15, wherein said electrochemical cell comprises circulating means configured to circulate feed/electrolyte solution through said electrochemical cell.

19. The electrochemical cell according to claim 15, wherein:
said electrochemical cell comprises a conductive separator that divides said cell into an anode compartment in electrical connection with said anode and a cathode compartment in electrical connection with said cathode; and,
said solution supply and withdrawal means are in fluid connection with said anode compartment but are not in fluid connection with said cathode compartment.

20. The electrochemical cell according to claim 19, wherein said separator is a proton-conductive separator.

21. The electrochemical cell according to claim 20, wherein said proton-conductive separator comprises at least one catalyst layer selected from the group consisting of:
at least one anode side catalyst layer comprising a catalyst selected from the group consisting of graphite, glassy carbon, lead dioxide, mixed aluminum-vanadium oxides on carbon, gold, silver, platinum, aluminum-doped platinum, ruthenium, palladium, rhodium, tantalum, niobium, molybdenum, tungsten (wolfram), iridium, osmium, and mixtures thereof; and,
at least one cathode side catalyst layer comprising a catalyst that comprises at least one component selected from the group consisting of:
metal oxides; and,
gold, nickel, molybdenum, platinum, ruthenium, palladium, iridium, zirconium, aluminum, lead, sulfides thereof, and alloys thereof.

22. The electrochemical cell according to claim 21, wherein said proton-conductive separator comprises a cathode side catalyst layer comprising a catalyst comprising a metal oxide selected from the group consisting of oxides of palladium, ruthenium, iridium, zirconium, aluminum, and lead; SnO₂; SbO₂; TaO₂; TiO₂; and Ti₄O₇.

23. The electrochemical cell according to claim 19, wherein said separator is an anion-conductive separator.

24. The electrochemical cell according to claim 23, wherein said anion-conductive separator comprises at least one catalyst layer selected from the group consisting of anode-side catalyst layers disposed on at least a part of said anode side of said separator and cathode-side catalyst layers disposed on at least a part of said cathode side of said separator.
